(19) United States
(12) Patent Application Publication
(10) Pub. No.: US 2008/0259777 A1
(43) Pub. Date: Oct. 23, 2008

(54) Optical Pickup Device and Optical Disc Device

(76) Inventors: Kouretsu Boku, Kyoto (JP); Hideki Hayashi, Nara (JP); Yohichi Saitoh, Osaka (JP); Hideki Aikoh, Osaka (JP); Takao Hayashi, Osaka (JP); Makoto Takashima, Nara (JP); Tomio Yamamoto, Hyogo (JP); Akira Yoshikawa, Nara (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/570,078

(22) PCT Filed: Mar. 15, 2006
(86) PCT No.: PCT/JP2006/030512

§ 371 Date: Dec. 6, 2006

(30) Foreign Application Priority Data
Mar. 17, 2005 (JP) 2005-076778

(51) Int. Cl. G11B 7/00

(52) U.S. Cl. 369/121

(57) ABSTRACT

An optical pickup device 11 according to the present invention includes: a light source 1 that emits a light beam; a condensing element 5 for condensing the light beam toward an information storage medium 14; and a protruding member 101, which comes closer to the information storage medium 14 than the condensing element 5 does when the condensing element 5 faces the information storage medium 14. The protruding member 101 is shaped so as to gradually protrude toward the information storage medium 14 in a tangential direction 21 of the information storage medium 14 rotating.

### TECHNICAL FIELD

The present invention relates to an optical pickup device and to an optical disk drive including the optical pickup device.

### BACKGROUND ART

A DVD (digital versatile disc), a type of optical disk medium, is known as an information storage medium which can store digital data six times as densely as a CD (compact disc) and on which a huge amount of data such as a movie or music can be written. As the amount of information to be stored has been further increasing recently, optical disk media with even bigger capacities are in higher and higher demand.

To increase the capacity of an optical disk medium, the storage density thereof needs to be increased, which can usually be done by decreasing the spot size of a laser beam to be radiated toward the optical disk medium during data reading and writing operations. And to decrease the spot size of a laser beam, the wavelength of the laser beam needs to be shortened and the numerical aperture (NA) of the objective lens needs to be increased. A DVD drive uses a light source that emits a laser beam with a wavelength of 660 nm and an objective lens with an NA of 0.6 in combination. Furthermore, optical disk media with even higher storage density, on which information can be stored five times as densely as on DVDs by using a blue laser beam with a wavelength of 405 nm and an objective lens with an NA of 0.85, have just been put on the market.

However, the greater the NA of an objective lens, the shorter the working distance (WD) between the objective lens and the optical disk medium. This means that the objective lens would collide against the optical disk medium more easily if the focus servo has failed to work accidentally or if the disk drive is subjected to vibrations while the drive is not operating. And if the objective lens gets scratched due to such a collision, the optical property of the objective lens deteriorates and the read/write performance declines eventually.

Patent Document No. 1 discloses an optical pickup device that can prevent an objective lens from getting scratched even in such a situation.

FIG. 7 is a cross-sectional view illustrating the optical pickup device 200 disclosed in Patent Document No. 1. The optical pickup device 200 includes an objective lens 220 for CDs or DVDs and another objective lens 230 for optical disk media with higher densities. The objective lens 230 includes a first lens 231 and a second lens 232. The optical pickup device 200 further includes a protruding member 240 for preventing the surface 233 of the first lens 231 from contacting with the optical disk medium even when there is a short working distance between the objective lens 230 and the optical disk medium.

The protruding member 240 is arranged near the first lens 231 and closer to the optical disk medium than the surface 233 of the first lens 231 is. And when the first lens 231 is about to collide against the optical disk medium, the protruding member 240 contacts with the optical disk medium in place of the first lens 231. By providing this protruding member 240, even if the focus servo has failed to work or if the disk drive is subjected to vibrations while not operating, it is possible to prevent the first lens 231 from getting scratched due to accidental contact with the optical disk medium.
Patent Document No. 1: Japanese Patent Application Laid-Open Publication No. 2001-067700

### DISCLOSURE OF INVENTION

### Problems to be Solved by the Invention

In the conventional optical pickup device, however, if some foreign matter such as dust is deposited on the surface of the protruding member 240 that is going to collide against the optical disk medium, then the surface of the optical disk medium may also get scratched by that foreign matter. Once the surface of the optical disk medium has been scratched, the data stored there is hard to read accurately, and sometimes becomes unreadable at all in a worst-case scenario.

In order to overcome the problems described above, an object of the present invention is to prevent an optical disk medium from getting scratched by such foreign matter that has been deposited on the surface of a protruding member even if the protruding member has collided against the optical disk medium.

### Means for Solving the Problems

An optical pickup device according to the present invention is characterized by including: a light source that emits a light beam; a condensing element for condensing the light beam toward an information storage medium; and a protruding member, which comes closer to the information storage medium than the condensing element does when the condensing element faces the information storage medium. The protruding member is shaped so as to gradually protrude toward the information storage medium in a tangential direction of the information storage medium rotating.

In one preferred embodiment, as viewed on a plane, which is parallel not only to the optical axis of the light beam being condensed by the condensing element toward the information storage medium but also to the tangential direction, the protruding member has an protuberant cross section.

In another preferred embodiment, as viewed on a plane, which is parallel not only to the optical axis of the light beam being condensed by the condensing element toward the information storage medium but also to the tangential direction, the protruding member has a trapezoidal cross section.

In still another preferred embodiment, as viewed on a plane, which is parallel not only to the optical axis of the light beam being condensed by the condensing element toward the information storage medium but also to the tangential direction, the protruding member has a curved cross section that is raised toward the information storage medium.

In this particular preferred embodiment, the protruding member has a cross section, of which the curvature at a downstream point in the rotational direction is smaller than the curvature at an upstream point.

In yet another preferred embodiment, a portion of the protruding member that comes closest to the information storage medium is curved.

In yet another preferred embodiment, as viewed on a plane, which is parallel not only to the optical axis of the light beam being condensed by the condensing element toward the information storage medium but also to the tangential direction, the protruding member has a cross section with an outline on which an acute angle is defined between a tangent to the outline and the optical axis of the light beam being condensed toward the information storage medium.

In this particular preferred embodiment, the angle formed between the tangent to the outline and the optical axis of the light beam being condensed toward the information storage medium is in the range of 10 degrees to less than 90 degrees.

In a specific preferred embodiment, the angle formed between the tangent to the outline and the optical axis of the light beam being condensed toward the information storage medium is in the range of 45 degrees to 80 degrees.

In yet another preferred embodiment, the optical pickup device further includes a pair of sidewall members, which is arranged so as to sandwich the protruding member in a radial direction of the information storage medium. The sidewall members extend in the tangential direction. And the pair of sidewall members is arranged so as to be more distant from the information storage medium than a portion of the protruding member that comes closest to the information storage medium.

In this particular preferred embodiment, the gap between the sidewall members themselves becomes narrowest in the vicinity of that portion of the protruding member that comes closest to the information storage medium.

An optical disk drive according to the present invention is characterized by including: the optical pickup device described above; a rotating section for rotating the information storage medium; a detecting section for detecting light that has been reflected from the information storage medium; and a signal processing section for generating at least one of a read signal and a servo signal based on the reflected light detected.

In one preferred embodiment, the optical disk drive further includes a control section for blowing off foreign matter that has been deposited on the protruding member by controlling the operations of the optical pickup device and the rotating section such that the protruding member is brought closer to the information storage medium being rotated.

### EFFECTS OF THE INVENTION

According to the present invention, the protruding member is shaped so as to gradually protrude toward an information storage medium in the tangential direction of the information storage medium rotating. When the information storage medium rotates, air current is produced between the information storage medium and the optical pickup device. As the protruding member is shaped so as to protrude gradually, the air current upstream of the protruding member is guided to the upper surface of the protruding member. Since there is an ample opening when the air current is going to flow onto the upper surface of the protruding member, a lot of air current flows onto the upper surface of the protruding member. As its channel width narrows near the upper surface of the protruding member, the air current comes to have an increased flow velocity and increased force to blow off the foreign matter on the protruding member. By blowing off the foreign matter on the protruding member, even if the protruding member has collided against the information storage medium, it is possible to prevent the information storage medium from getting scratched by the foreign matter that was deposited on the surface of the protruding member. In addition, since the air current with high flow velocity flows along the surface of the information storage medium, the foreign matter that was deposited on the information storage medium can also be blown off.

### BRIEF DESCRIPTION OF DRAWINGS

FIG. 1 shows an optical disk drive according to a first preferred embodiment of the present invention.

FIG. 2A is a cross-sectional view illustrating a protruding member according to the first preferred embodiment of the present invention.

FIG. 2B is a perspective view illustrating the protruding member of the first preferred embodiment of the present invention.

FIG. 3A is a cross-sectional view illustrating another protruding member according to the first preferred embodiment of the present invention.

FIG. 3B is a perspective view illustrating the protruding member of the first preferred embodiment of the present invention.

FIG. 4A is a cross-sectional view illustrating still another protruding member according to the first preferred embodiment of the present invention.

FIG. 4B is a cross-sectional view illustrating yet another protruding member according to the first preferred embodiment of the present invention.

FIG. 4C is a cross-sectional view illustrating yet another protruding member according to the first preferred embodiment of the present invention.

FIG. 5A is a perspective view illustrating a protruding member according to a second preferred embodiment of the present invention.

FIG. 5B is a perspective view illustrating a protruding member and sidewall members according to the second preferred embodiment of the present invention.

FIG. 5C is a side view illustrating the protruding member and the sidewall members of the second preferred embodiment of the present invention.

FIG. 6 is a plan view illustrating a protruding member and sidewall members according to the second preferred embodiment of the present invention.

FIG. 7 illustrates a conventional optical pickup device with a protruding member.

### DESCRIPTION OF REFERENCE NUMERALS

1 light source
2 beam splitter
3 collimator lens
4 mirror
5 objective lens
6 actuator coil
7 multi-lens
8 photodiode
9 optical disk drive
10 optical pickup device
11 signal processor
12 servo controller
13 optical disk medium
14 spindle motor
15 traverse motor
16 lens holder
100 protruding member
102 sidewall member

### BEST MODE FOR CARRYING OUT THE INVENTION

Hereinafter, preferred embodiments of the present invention will be described with reference to the accompanying drawings.

### Embodiment 1

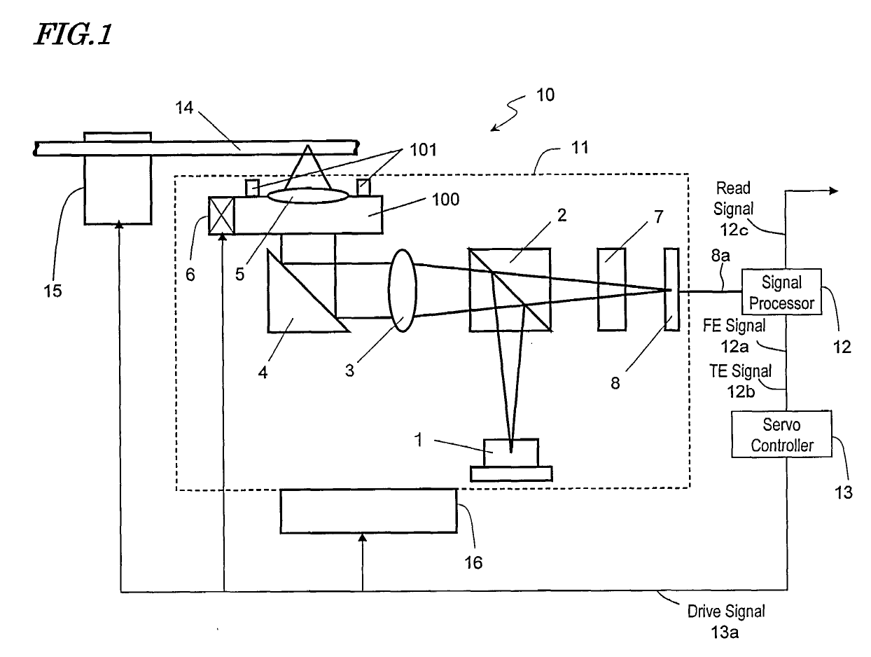

A first preferred embodiment of an optical pickup device and optical disk drive according to the present invention will be described with reference to FIGS. 1 through 4C.

FIG. 1 shows an optical disk drive 10 according to this preferred embodiment. The optical disk drive 10 may be a recorder/player, a player or a recorder for reading and/or writing data from/on an optical disk medium 14. The optical disk drive 10 includes an optical pickup device 11, a signal processor 12, a servo controller 13, a spindle motor 15, and a traverse motor 16.

First, it will be outlined how this optical disk drive 10 operates.

The optical pickup device 11 radiates a light beam toward the optical disk medium 14, detects the light that has been reflected from the optical disk medium 14, and then outputs a light intensity signal 8a representing where and how much reflected light was detected.

In accordance with the light intensity signal 8a supplied from the optical pickup device 11, the signal processor 12 generates and outputs various signals including a focus error (FE) signal 12a, representing the focusing state of the light beam on the optical disk medium 14, and a tracking error (TE) signal 12b representing the relative position of the light beam spot to the track on the optical disk medium 14.

The FE signal 12a and the TE signal 12b will be referred to herein as “servo signals” collectively. In response to these servo signals, the servo controller 13 generates and outputs a drive signal 13a. The drive signal 13a is input to the actuator coil 6 of the optical pickup device 11, thereby adjusting the position of the objective lens 5. In this manner, the focal point of the light beam radiated toward the optical disk medium 14 is controlled so as not to shift from the information storage layer. The servo controller 13 also controls the operations of the spindle motor 15 and the traverse motor 16. The spindle motor 15 rotates the optical disk medium 14 at a rotational velocity corresponding to the specified read/write rate. The traverse motor 16 moves the optical pickup device 11 to a target read/write location in the radial direction of the optical disk medium 14.

With the focal point of the light beam controlled so as not to shift from the information storage layer, the signal processor 12 generates and outputs a read signal 12c based on the light intensity signal 8a. The read signal 12c represents the data that was written on the optical disk medium 14. In this manner, data can be read from the optical disk medium 14. Also, by setting the power of the light beam higher than during reading, data can be written on the optical disk medium 14.

Next, the optical pickup device 11 will be described. The optical pickup device 11 includes a light source 1, a beam splitter 2, a collimator lens 3, a mirror 4, an objective lens 5, a lens holder 100, a protruding member 101, an actuator coil 6, a multi-lens 7, and a photodiode 8.

The light source 1 may be a blue-ray-emitting GaN-based semiconductor laser diode and emits a light beam. The light source 1 also produces coherent light to read and write data from/on the information storage layer of the optical disk medium 14. The beam splitter 2 splits the light beam that has been emitted from the light source 1. The collimator lens 3 transforms the light beam that has passed the beam splitter 2 into a parallel light beam. The mirror 4 reflects the light beam that has passed the collimator lens 3 toward the objective lens 5. The objective lens 5 condenses the incoming light beam onto the information storage layer of the optical disk medium 14. The actuator coil 6 changes the positions of the lens holder 100, to which the objective lens 6 is attached, either perpendicularly or parallel to the surface of the optical disk medium 14 according to the level of the input drive signal 13a.

The light beam that has been reflected from the information storage layer of the optical disk medium 14 goes in the opposite direction, compared to when radiated from the light source 1 in the optical pickup device 11. Then, the returning light beam passes the beam splitter 2 to enter the multi-lens 7, which condenses the light beam onto the photodiode 8. The photodiode 8 is a photodetector for detecting the light beam that has been reflected from the information storage layer of the optical disk medium 14 and generating an electrical signal representing where and how much light was detected (i.e., the light intensity signal 8a). Optionally, the photodiode 8 may include a plurality of photosensitive elements. On receiving the light intensity signal 8a, the signal processor 12 generates the FE signal 12a and the TE signal 12b by reference to the information about which photosensitive element output the light intensity signal 8a, too.

The protruding member 101 is arranged beside the objective lens 5 on the lens holder 100. When the optical disk medium 14 is loaded into the optical disk drive 10 and faces the objective lens 5, the protruding member 101 is located closer to the optical disk medium 14 than the objective lens 5 is. The protruding member 101 may be molded together with the lens holder 100, for example, and have its surface coated with a soft resin. The objective lens 5 may come unusually close to the optical disk medium 14 when the focus servo fails to work or when the disk drive is subjected to vibrations while not operating. In such a situation, the protruding member 101 contacts with the optical disk medium 14 in place of the objective lens 5. By providing this protruding member 101, even if focus servo has failed to work accidentally or if the disk drive is subjected to a lot of vibrations while not operating, it is still possible to prevent the objective lens 5 from getting scratched due to unwanted contact with the optical disk medium 14.

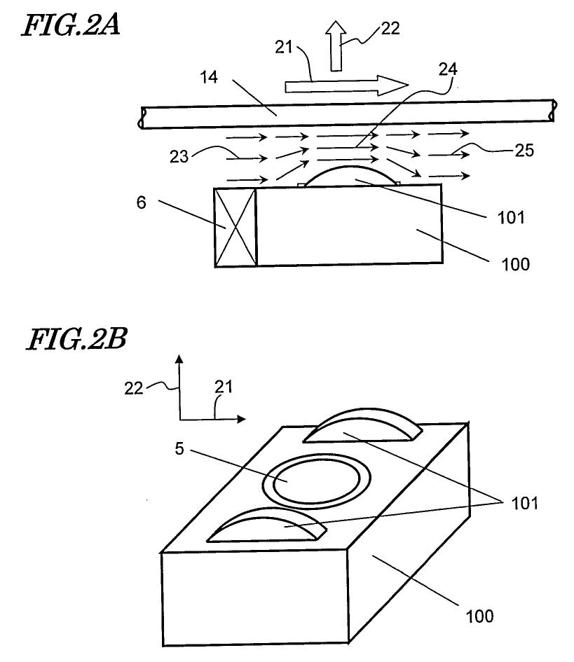

Hereinafter, the protruding member 101 will be described in further detail with reference to FIGS. 2A and 2B, which are respectively a cross-sectional view and a perspective view of the protruding member 101.

The protruding member 101 includes portions to come closer to the information storage medium 14 than the highest point of the objective lens 5 does, and is shaped so as to gradually protrude toward the optical disk medium 14 in the tangential direction 21 of the optical disk medium 14 rotating. In the example illustrated in FIGS. 2A and 2B, as viewed on a plane, which is parallel not only to the optical axis 22 of the light beam being condensed by the objective lens 5 toward the optical disk medium 14 but also to the tangential direction 21, the protruding member 101 has a gently elevated cross section, of which the outline is raised toward the optical disk medium 14.

As the optical disk medium 14 rotates, air current 23, 24 and 25 is produced between the optical disk medium 14 and the optical pickup device 11. As the protruding member 101 is shaped so as to protrude gradually, the air current 23 upstream of the protruding member 101 is guided to the upper surface of the protruding member 101. Since there is an ample opening when the air current is flowing onto the upper surface of the protruding member 101 (i.e., as there is a wide gap between the optical disk medium 14 and the protruding member 101), a lot of air current flows onto the upper surface (or to the top) of the protruding member 101. As its channel width narrows near the upper surface of the protruding member 101 (where the protruding member 101 is located closer to the optical disk medium 14B), the air current 24 comes to have an increased flow velocity and increased force to blow off the foreign matter on the protruding member 101. By blowing off the foreign matter on the protruding member 101, even if the protruding member 101 has collided against the optical disk medium 14, it is possible to prevent the optical disk medium 14 from getting scratched by the foreign matter that was deposited on the surface of the protruding member 101.

Also, the top portions of the protruding member 101 to come closest to the optical disk medium 14 are curved. That is why even if the protruding member 101 collides against the optical disk medium 14, the optical disk medium 14 does not get scratched easily. Also, since the top portions of the protruding member 101 are curved, the foreign matter that has been once deposited on the protruding member 101 can drop down the protruding member 101 easily.

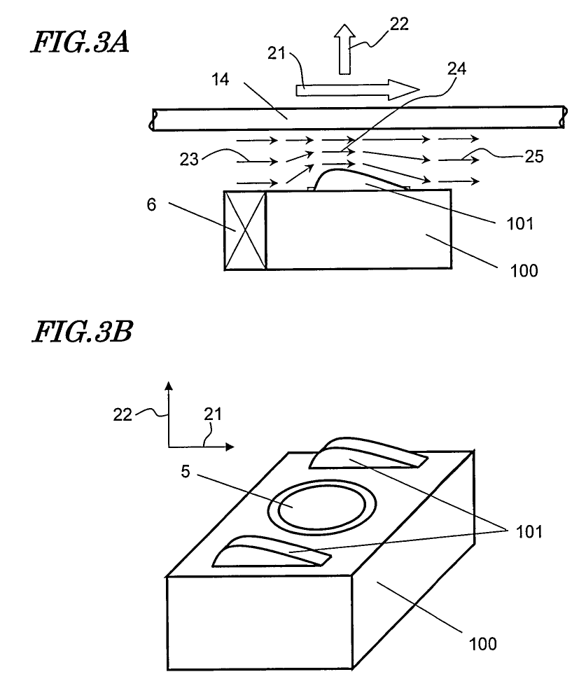

Optionally, the protruding member 101 may have a cross section, of which the curvature at a downstream point in the rotational direction is smaller than the curvature at an upstream point, as shown in FIGS. 3A and 3B, which are respectively a cross-sectional view and a perspective view of the protruding member 101.

Generally speaking, air current, flowing on the surface of an object, is deposited on the surface and decelerated inside a very thin layer near the surface due to its own viscosity. This layer is called a “boundary layer”. Inside of the boundary layer, the air current has a velocity gradient. Outside of the boundary layer, however, the air current becomes a uniform flow with a constant flow velocity. In the protruding member 101 shown in FIG. 2A, the pressure on the air current flowing on the curved surface reaches its maximum at the front end, gradually decreases as the air current flows along the surface to reach its minimum at the top, and then increases toward the rear end. In the front portion (i.e., the first half as viewed in the rotational direction) of the protruding member 101, the pressure decreases as the air current goes farther. As a result, the boundary layer becomes a smooth flow that gradually increases its velocity. After the air current has passed the top of the protruding member 101 to reach its the rear portion (i.e., the second half as viewed in the rotational direction), however, the pressure increases as the air current goes farther, thus interfering with the airflow. And at some point, backflow produces a vortex and sometimes separates the boundary layer from the surface. Once the boundary layer has been separated, a wake is produced in the air current between the optical disk medium 14 and the protruding member 101, thus increasing the resistance and decreasing the flow velocity of the overall air current. That is why the boundary layer should not be separated.

To minimize the effects caused by the separation of the boundary layer, the rear portion of the protruding member 101 may have a decreased curvature such that the pressure on the air current has a gentler gradient. In that case, the separation point of the boundary layer can be shifted forward (i.e., the separation can be postponed) and the wake and its resistance can be decreased, thus minimizing the decrease in the flow velocity of the overall air current. In the protruding member 101 shown in FIGS. 3A and 3B, the rear curved portion of the protruding member 101 has a smaller curvature than the front curved portion thereof. As a result, the air current turbulence can be decreased in the rear portion, the flow velocity can be further increased near the top portion, and the air current force to blow off the foreign matter on the protruding member 101 can be increased.

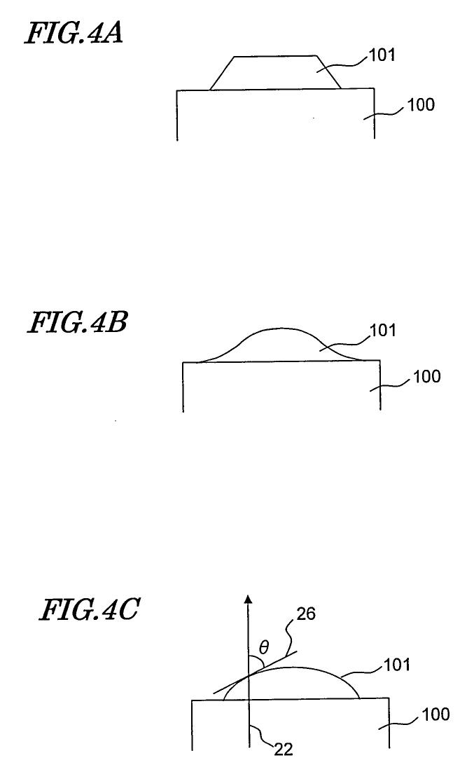

It should be noted that the protruding member 101 may have a shape that gradually protrudes toward the optical disk medium 14 so as to guide the air current near the protruding member 101 onto the top of the protruding member 101. Therefore, the protruding member 101 may also have a trapezoidal cross section such as that shown in FIG. 4A. Alternatively, the protruding member 101 may also have a cross section with curved slopes that are raised toward the lens holder 100 as shown in FIG. 4B. Furthermore, to guide the air current from an upstream point on the protruding member 101 onto the top of the protruding member 101, only the upstream portion of the protruding member 101 needs to have a gradually protruding shape, but the downstream portion thereof need not.

Also, to guide the air current near the protruding member 101 onto the top of the protruding member 101, the protruding member 101 preferably has a cross section with an outline on which an acute angle θ is defined between a tangent 26 to the outline and the optical axis 22 of the light beam as shown in FIG. 4C. More specifically, the angle θ is formed between the tangent 26 drawn toward the optical disk medium 14 and the optical axis 22 directed toward the optical disk medium 14. The angle θ may be in the range of 10 degrees to less than 90 degrees, for example. To make the air current flow more smoothly along the surface of the protruding member 101, the angle θ is more preferably in the range of 45 degrees to 80 degrees.

Optionally, as a cleaning operation mode to blow off the foreign matter that has been deposited on the protruding member 101, the servo controller 13 may perform the operation of brining the protruding member 101 closer to the optical disk medium 14 while rotating the optical disk medium 14. By making the protruding member 101 approach the optical disk medium 14 to the point that the protruding member 101 does not contact with the optical disk medium 14, the air current can have an even narrower channel, a further increased flow velocity, and increased force to blow off the foreign matter on the protruding member 101.

### Embodiment 2

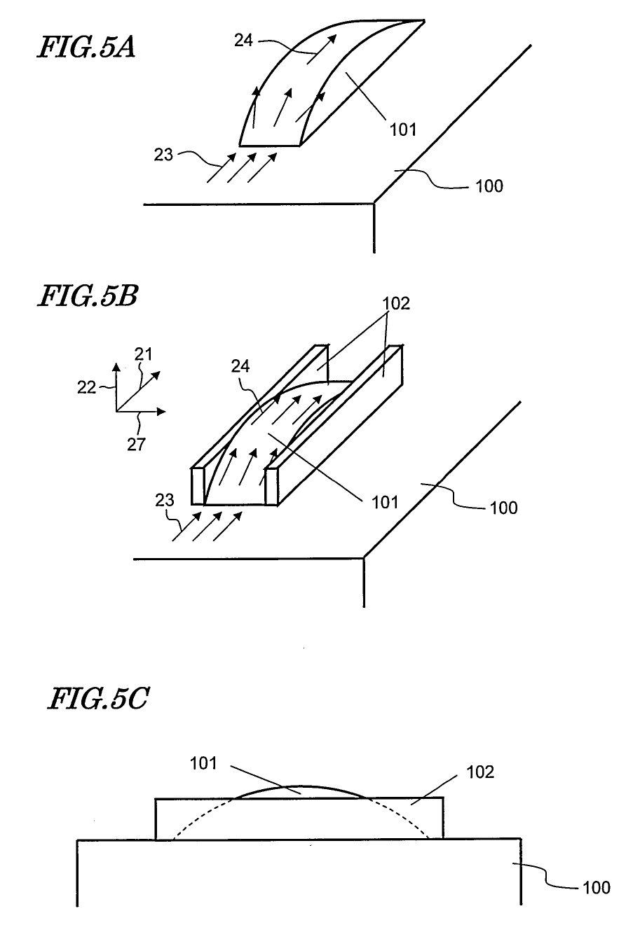

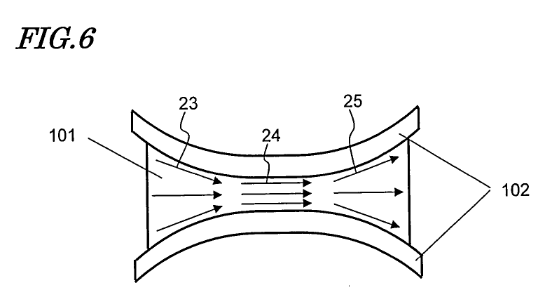

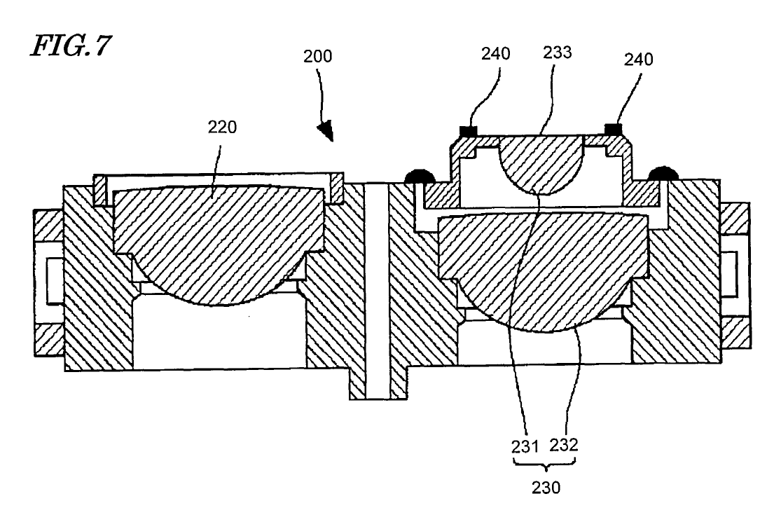

Hereinafter, a second preferred embodiment of an optical pickup device according to the present invention will be described with reference to FIGS. 5A through 6.

FIG. 5A is a perspective view illustrating the protruding member 101 that has already been described with reference to FIGS. 2A and 2B. FIGS. 5B and 5C are respectively a perspective view and a side view illustrating a protruding member 101 and sidewall members 102 that are provided for the lens holder 100 of the optical pickup device 11 of this preferred embodiment. The optical disk drive 10 and optical pickup device 11 of this preferred embodiment include not only all components of their counterparts of the first preferred embodiment described above but also the sidewall members 102. The other components function just like their counterparts of the first preferred embodiment, and the detailed description thereof will be omitted herein.

As shown in FIGS. 5B and 5C, a pair of sidewall members 102 is arranged on both sides of the protruding member 101 in the radial direction 27 of the optical disk medium 14. Each of these sidewall members 102 extends in the tangential direction 21. The pair of sidewall members 102 is arranged so as to be more distant from the optical disk medium 14 than the top portion of the protruding member 101 where the sidewall members 102 and the protruding member 101 approach the optical disk medium 104 most. That is to say, in the vicinity of the top portion of the protruding member 101, the protruding member 101 comes closer to the optical disk medium 14 than the sidewall members 102 do. On the other hand, in the upstream and downstream regions of the air current that flows along the protruding member 101, the sidewall members 102 come closer to the optical disk medium 14 than the protruding member 101 does.

As shown in FIG. 5A, if no sidewall members 102 are provided, part of the air current that has flowed along the protruding member 101 may change directions on the way and start to flow toward the side surfaces of the protruding member 101. In that case, the air current flowing near the top portion of the protruding member 101 may have a decreased flow rate.

On the other hand, if the sidewall members 102 are arranged on both sides of the protruding member 101 as shown in FIG. 5B, then the sidewall members 102 makes that part of the air current that is about to flow toward the side surfaces of the protruding member 101 continue to flow along the upper surface of the protruding member 101. As a result, the air current flowing on the upper surface of the protruding member 101 comes to have an increased flow rate and increased force to blow off the foreign matter on the protruding member 101. The sidewall members 102 are lower than the top portion of the protruding member 101. That is why it is the top portion of the protruding member 101, not the sidewall members 102, that contacts with the optical disk medium 14. Consequently, the sidewall members 102 never interfere with the action of the protruding member 101.

Optionally, the gap between the pair of sidewall members 102 themselves may be narrowest near the top portion of the protruding member 101 that comes closest to the optical disk medium 14 as shown in FIG. 6, which is a plan view illustrating the protruding member 101 and the sidewall members 102. In FIG. 6, the gap between the sidewall members 102 themselves becomes the narrowest near the top portion of the protruding member 101 but widens from the top toward both ends of the protruding member 101. By adopting sidewall members 102 with such a shape, not just the channel width of the air current at the top portion of the protruding member 101 but also the gap between the pair of sidewall members 102 are narrowed at the same time, thus further increasing the flow velocity of the air current near the top portion of the protruding member 101 and blowing off the foreign matter on the protruding member 101 more perfectly. Since the sidewall members 102 have a widened opening upstream of the air current, more air current can be guided onto the upper surface of the protruding member 101. Near the top of the protruding member 101, however, the gap between the sidewall members 102 narrows, thus increasing the flow velocity of the air current. And the gap between the sidewall members 102 widens again downstream of the channel, and therefore, the air can be exhausted smoothly there. As a result, the flow velocity is further increased near the top of the protruding member 101. By additionally providing such sidewall members 102 for the protruding member 101 that comes very close to the optical disk medium 14, the air current can have further increased force to blow off the foreign matter on the protruding member 101.

The protruding member 101 and sidewall members 102 may be molded either together with, or separately from, the lens holder 100.

In the preferred embodiments described above, the light source 1 is supposed to be a blue-ray-emitting laser diode considering that the shorter the wavelength of a light beam, the more foreign particles, ionized by the excitation of the light beam, for example, tend to deposit themselves. However, the amount of the foreign matter deposited on the protruding member 101 depends on not only the wavelength of the light source but also how much dust is included in the surrounding environment. That is why the wavelength of the light beam emitted from the light source 1 does not have to be that of a blue ray.

### INDUSTRIAL APPLICABILITY

As described above, the optical pickup device and optical disk drive of the present invention can be used particularly effectively in the technology of reading and/or writing data optically from/on an information storage medium.

1. An optical pickup device comprising:
a light source that emits a light beam;
a condensing element for condensing the light beam toward an information storage medium; and
a protruding member, which comes closer to the information storage medium than the condensing element does when the condensing element faces the information storage medium,
wherein the protruding member is shaped so as to gradually protrude toward the information storage medium in a tangential direction of the information storage medium rotating.

2. The optical pickup device of claim 1, wherein as viewed on a plane, which is parallel not only to the optical axis of the light beam being condensed by the condensing element toward the information storage medium but also to the tangential direction, the protruding member has an protuberant cross section.

3. The optical pickup device of claim 1, wherein as viewed on a plane, which is parallel not only to the optical axis of the light beam being condensed by the condensing element toward the information storage medium but also to the tangential direction, the protruding member has a trapezoidal cross section.

4. The optical pickup device of claim 1, wherein as viewed on a plane, which is parallel not only to the optical axis of the light beam being condensed by the condensing element toward the information storage medium but also to the tangential direction, the protruding member has a curved cross section that is raised toward the information storage medium.

5. The optical pickup device of claim 4, wherein the protruding member has a cross section, of which the curvature at a downstream point in the rotational direction is smaller than the curvature at an upstream point.

6. The optical pickup device of claim 1, wherein a portion of the protruding member that comes closest to the information storage medium is curved.

7. The optical pickup device of claim 1, wherein as viewed on a plane, which is parallel not only to the optical axis of the light beam being condensed by the condensing element toward the information storage medium but also to the tangential direction, the protruding member has a cross section with an outline on which an acute angle is defined between a tangent to the outline and the optical axis of the light beam being condensed toward the information storage medium.

8. The optical pickup device of claim 7, wherein the angle formed between the tangent to the outline and the optical axis of the light beam being condensed toward the information storage medium is in the range of 10 degrees to less than 90 degrees.

9. The optical pickup device of claim 8, wherein the angle formed between the tangent to the outline and the optical axis of the light beam being condensed toward the information storage medium is in the range of 45 degrees to 80 degrees.

10. The optical pickup device of claim 1, further comprising a pair of sidewall members, which is arranged so as to sandwich the protruding member in a radial direction of the information storage medium,
wherein the sidewall members extend in the tangential direction, and
wherein the pair of sidewall members is arranged so as to be more distant from the information storage medium than a portion of the protruding member that comes closest to the information storage medium.

11. The optical pickup device of claim 10, wherein the gap between the sidewall members themselves becomes narrowest in the vicinity of that portion of the protruding member that comes closest to the information storage medium.

12. An optical disk drive comprising:
the optical pickup device of claim 1;
a rotating section for rotating the information storage medium;
a detecting section for detecting light that has been reflected from the information storage medium; and
a signal processing section for generating at least one of a read signal and a servo signal based on the reflected light detected.

13. The optical disk drive of claim 12, further comprising a control section for blowing off foreign matter that has been deposited on the protruding member by controlling the operations of the optical pickup device and the rotating section such that the protruding member is brought closer to the information storage medium being rotated.
